(19) United States
(12) Patent Application Publication
(10) Pub. No.: US 2005/0012816 A1
(43) Pub. Date: Jan. 20, 2005

(54) Snap-in roller

(76) Inventor: Donald A. Becken, Burbank, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/621,865

(22) Filed: Jul. 17, 2003

(51) Int. Cl. H04N 5/253

(52) U.S. Cl. 348/107

(57) ABSTRACT

The invention provides a roller wheel assembly for sliding patio doors or the like that provides a quick and economical way of installing and retaining the assembly in the door installation. To achieve this result, the assembly employs at least one retaining member that flares outward with respect to the outer surface of the outer housing of the assembly, and at least one mounting tab affixed to an end of the outer housing. Once inserted through a pre-fabricated hole in the lower rail of the patio door, the assembly is retained in its proper location with respect to the door as the material wall thickness of the rail is captured between the retaining member and the mounting tab.

### BACKGROUND OF THE INVENTION

The present invention relates generally to roller assemblies for patio doors, and more particularly to an improvement in said roller assemblies that provides a quick and economical means of installing and retaining roller assemblies in sliding patio doors.

A variety of roller assemblies have been devised over the years for use in sliding patio door installations. However, all too often these roller assemblies are difficult to install and retain in the rails of the patio doors they are mounted to. In many cases additional hardware is necessary which increases the overall unit cost and increases installation costs because more time is need to properly position the roller assembly. Positioning and retaining such roller assemblies is an extremely important aspect of any patio door installation because the weight of the doors is concentrated on the rollers; therefore, it is imperative that rollers remain in proper position to support the door and allow for uninhibited door operation.

For the foregoing reasons there is a need for a roller assembly that is easy to install and retain in position on a patio door installation and offers a cost effective approach to accomplishing these goals without compromising the overall safety and performance of the patio door installation.

### SUMMARY OF THE INVENTION

The present invention is directed to a roller assembly that is particularly suitable for use with sliding patio doors and satisfies the needs advanced above by providing a quick and economical way of installing and retaining rollers in sliding patio doors.

In accordance with the present invention, a roller assembly or snap-in roller assembly, comprises an outer housing having an outer surface, an inner housing, at least two roller grooved wheels affixed to the inner housing to maintain the wheels in a fixed position relative to each other, and an adjustment mechanism which adjusts the inner housing to a desired position within the outer housing.

To retain the assembly in position in the patio door installation, at least one retaining member is either incorporated into the outer housing (i.e., is part of the outer housing) or is a separate member that is attached to the outer housing. The retaining member itself comprises a base portion and an end portion, wherein the base portion is positioned at a first height that is substantially flush with the outer surface of the outer housing and the end portion projects away from the outer surface of the outer housing to a second height that is greater than the first height relative to the outer surface of the outer housing. Additionally, at least one mounting tab removably connected to the outer housing is provided.

To install the assembly, the assembly is inserted through a prefabricated hole in a rail (typically the lower rail) of a sliding patio door, the rail having a wall thickness. The assembly is then positioned in the hole so that the wall thickness of the rail is captured between the at least one retaining member and the at least one mounting tab to retain the assembly in its proper location with respect to the patio door.

### BRIEF DESCRIPTION OF THE DRAWINGS

These and other features, aspects and advantages of the present invention will become better understood with regard to the following description, appended claims and accompanying drawings where:

FIG. 1 is a top/side perspective view of the snap-in roller assembly;

FIG. 2 is a bottom/side perspective view of the snap-in roller assembly;

FIG. 3 is a bottom/end perspective view of the snap-in roller assembly;

FIG. 4 is an exploded assembly view of the snap-in roller assembly;

FIG. 5 is cut-away view showing the roller assembly inserted partially through a fabricated hole in a patio door rail; and

FIG. 6 is a cut-away view showing the roller assembly fully inserted through a fabricated hole in a patio door rail.

### DETAILED DESCRIPTION OF THE INVENTION

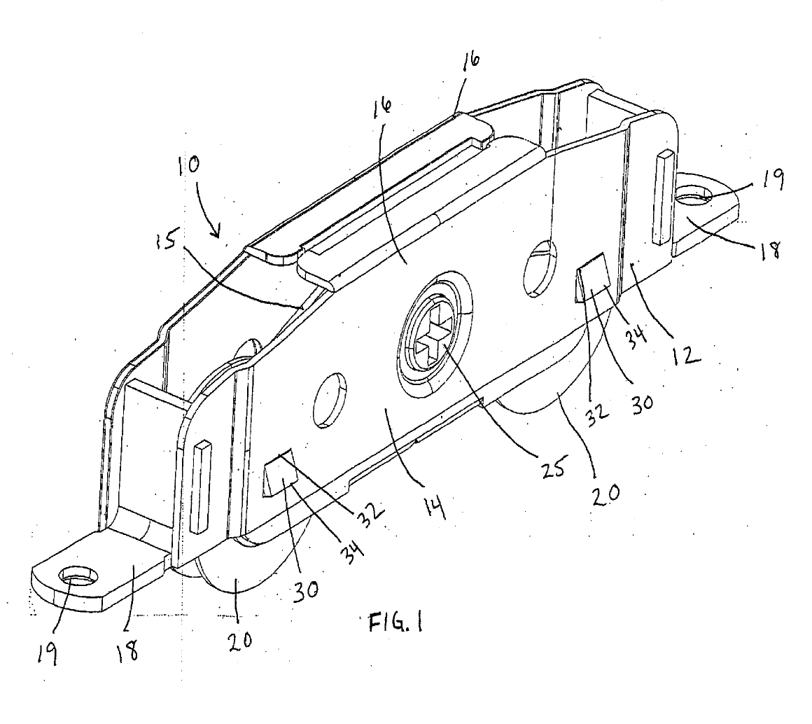

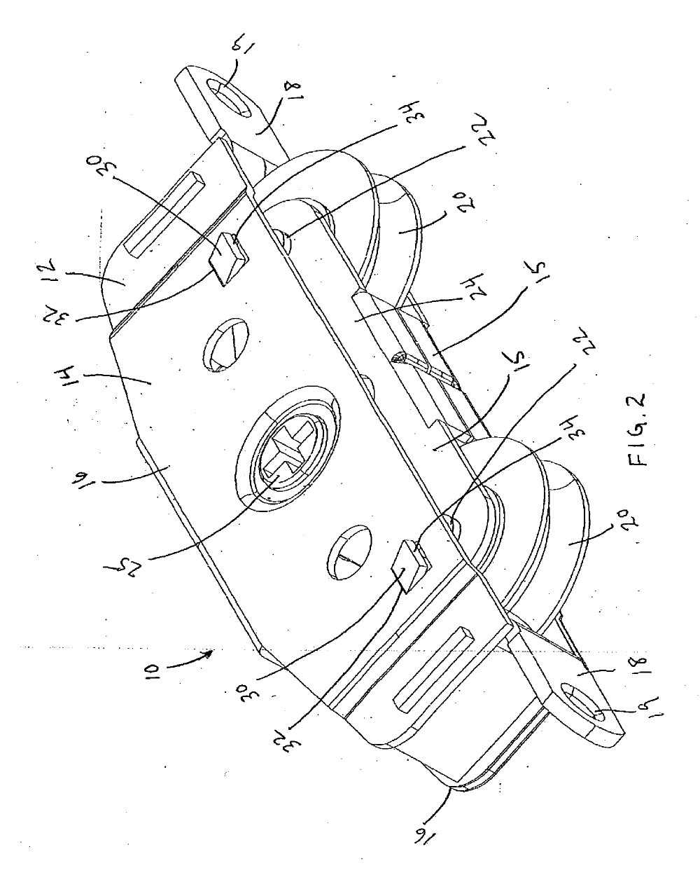

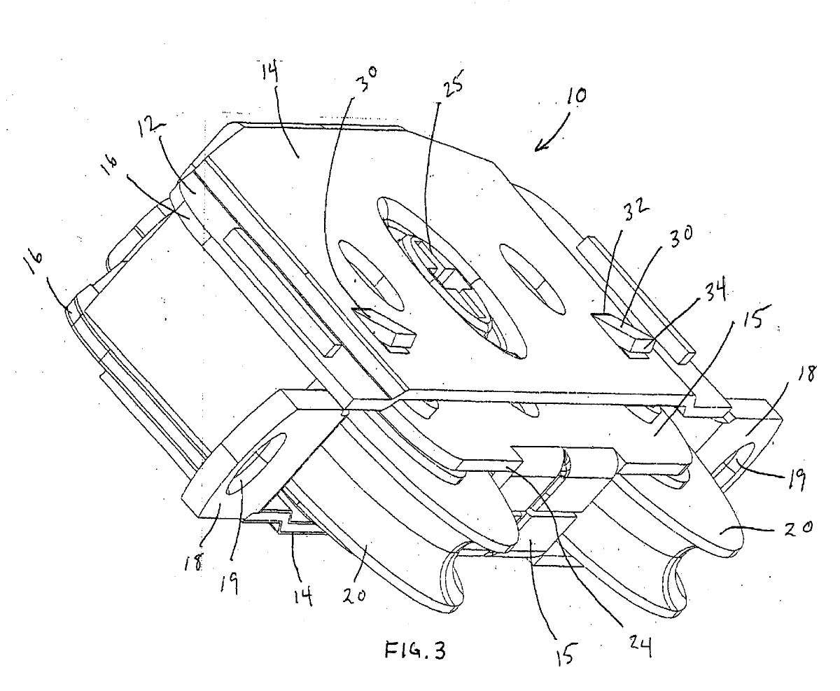

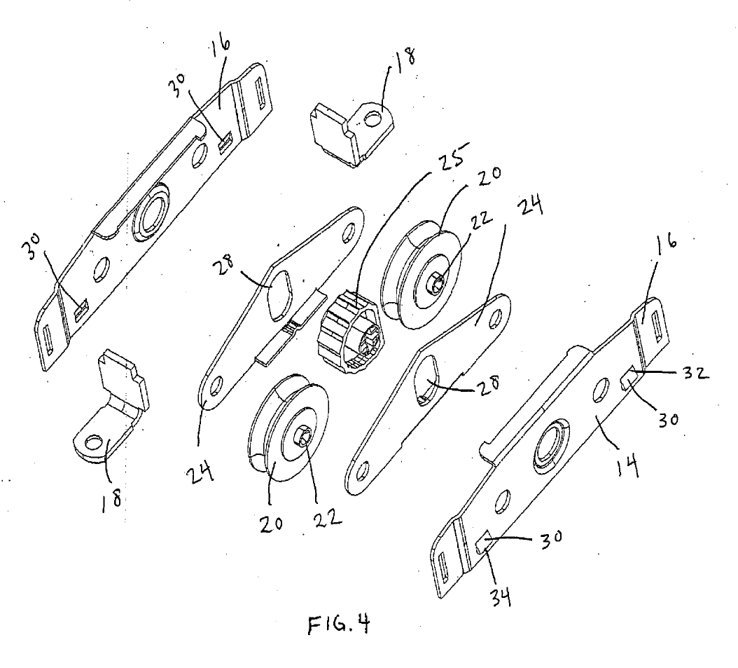

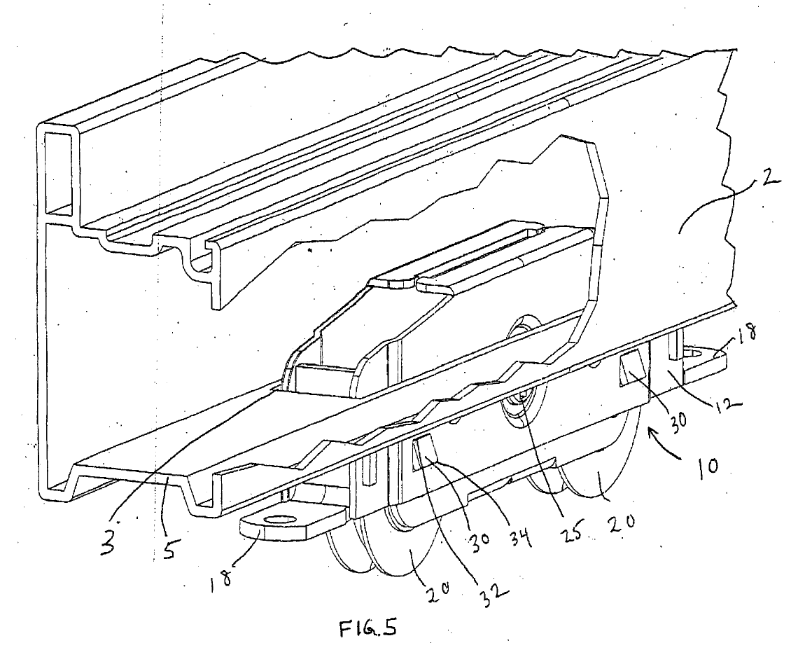

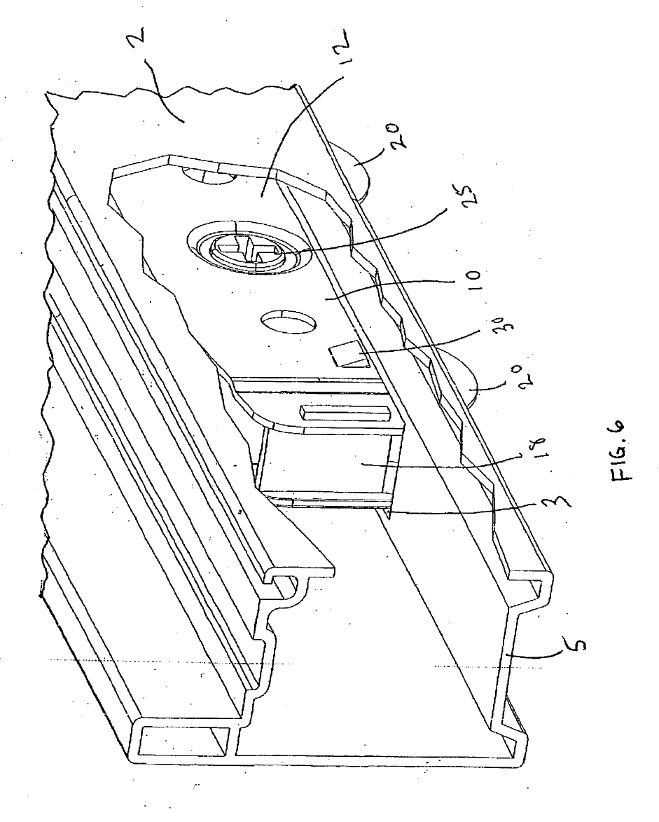

Referring to FIGS. 1 through 6, a snap-in roller wheel assembly 10 for sliding patio doors, or other applications that require the use of roller wheel assemblies, is shown in accordance with an embodiment of the invention. The snap-in roller assembly 10 consists of an outer housing or outer housing assembly 12, an inner housing or inner housing assembly 15, and an adjustment mechanism 25, which could be a cam driven mechanism (as shown) or any other means capable of adjusting the height of the inner housing within the outer housing. Focusing on FIGS. 1 and 4, the outer housing 12 comprises an outer surface 14 and at least one mounting tab 18 that can be either a separate component or incorporated into the outer housing itself. In one embodiment, the outer housing consists of two outer housing plates 16 separated and held together by at least one mounting tab 18, however the outer housing can also take the form of a one-piece unit. In one embodiment, two mounting tabs 18 are employed. The mounting tabs can be of various styles and orientation depending on the (mounting) requirements. The mounting tabs 18 are typically located at opposite ends of the roller assembly. In the embodiment shown in FIGS. 1-6, the mounting tabs 18 are shown as corner angle brackets and have portions defining mounting holes 19, however the mounting holes are optional. On the outer housing 12 or on each outer housing plate when plates are employed, there is at least one retaining member 30. The at least one retaining member 30 can be integrated or manufactured into the outer housing 12 (or each outer housing plate 16), i.e., the retaining member is part of the outer housing or housing plates, or can be a separate component that attaches directly to the outer housing 12 or each outer housing plate 16.

The at least one retaining member 30 has a base portion 32 and an end portion 34, wherein the base portion 32 is positioned at a first height that is substantially flush with the outer surface 14 of the outer housing 12 and the end portion 34 projects away from the outer surface 14 of the outer housing 12 to a second height above the outer surface 14 that is greater than the first height relative to the outer surface 14 (the height parameter is based on the distance moving away from the outer surface of the outer housing). In some instances the base portion 32 will be coplanar with the outer surface 14 of the outer housing 12. In one embodiment, the at least one retaining member 30 is a flared tab-like member that projects outwardly in a linear path from the first height at the base portion 32 to the second height at the end portion 34. Where housing plates 16 make up the outer housing 12, additional embodiments exist; for example, in one embodiment each parallel plate 16 of the outer housing 12 has at least one retaining members, and in yet another embodiment, each parallel plate 16 has two equally spaced substantially collinear retaining members. The spacing between the retaining members is set according to the requirement of the specific patio door installation. Typically, the retaining members 30 are substantially rigid, but could also be altered to offer some degree of resiliency depending on the application. Additionally, the retaining members 30 could be fully adjustable wherein the outward projection of the end portion could be adjusted outwardly (manually or automatically) away from the outer surface 14 of the outer housing 12 to different height locations.

Contained within the outer housing 12, is an inner housing assembly 15, that consists of pair of roller wheels 20, which can be optionally grooved, two roller wheel rivet axles 22, and two inner housing plates 24, each plate containing a slot 28 therein that accepts a portion of the adjustment mechanism 25 to limit travel of the inner housing 15 to a substantially vertical path with respect to the outer housing 12. In an alternative embodiment, the inner housing does not employ housing plates, but instead is a one-piece housing. The two inner housing plates 24 are parallel to each other and retain the two roller wheels 20 in tandem between plates 24. Roller wheels 20 are retained or secured in place by two roller wheel rivet pins, not shown. The pair of roller wheels 20 are received between the opposed, open parallel plates of the inner housing and are positioned at opposite ends of each other.

To install the snap-in roller 10, the roller assembly 10 is maneuvered through a fabricated hole 3 in the lower rail 2 of a sliding patio door. Once inserted, the roller assembly 10 is retained in the hole 3 having achieved proper location by capturing the material wall thickness 5 of the rail 2 in between the retaining members 30 and the mounting tabs 18 located on each end of the roller assembly.

The invention thus described is a snap-in roller assembly that is quick and economical to install and is able to retain itself in the bottom rail of a sliding patio door by employing at least one retaining member.

Although the present invention has been described relative to a specific embodiment thereof, it is not so limited; for example, the retaining members can be of various styles and orientation and can be used in varying quantities all depending on the requirements of the patio door installation where the snap-in roller is installed. Thus, it will be understood that many additional changes in the details, materials, steps and arrangement of parts, which have been herein described and illustrated in order to explain the nature of the invention, may be made by those skilled in the art within the principle and scope of the invention as expressed in the appended claims.

1. A snap-in roller assembly adapted for installation in a hollow rail of a sliding door, the hollow rail having a wall with an interior surface and an exterior surface, the assembly comprising:
an outer housing having an outer surface;
an inner housing;
at least two roller wheels affixed to the inner housing to maintain the wheels in a fixed position relative to each other;
an adjustment mechanism which adjusts the inner housing to a desired position within the outer housing;
at least one retaining member incorporated into the outer housing, the retaining member comprising a base portion and an end portion, wherein the base portion is positioned at a first height that is substantially flush with the outer surface of the outer housing and the end portion projects away from the outer surface of the outer housing to a second height that is greater than the first height relative to the outer surface; and
at least one mounting tab affixed to the outer housing, the at least one retaining member and the at least one mounting tab positioned so that, when the assembly is installed in the hollow rail, the end portion of the retaining member engages the interior surface of the wall and the mounting tab engages the exterior surface of the wall, thereby retaining the assembly in the sliding door.

2. The assembly of claim 1 wherein the inner housing is a pair of parallel plates each containing a slot therein that accepts a portion of the adjustment mechanism to limit travel of the inner housing to a substantially vertical path with respect to the outer housing.

3. The assembly of claim 1 wherein the outer housing is a pair of substantially parallel plates which overlie the inner housing and limits travel of the inner housing to a vertical path while substantially limiting horizontal movement.

4. The assembly of claim 3 wherein each parallel plate of the outer housing has at least one retaining member.

5. The assembly of claim 3 wherein each parallel plate has two equally spaced substantially collinear retaining members.

6. The assembly of claim 1 wherein the at least one retaining member is a flared tab-like member that projects outwardly in a linear path from the first height at the base portion to the second height at the end portion.

7. The assembly of claim 5 wherein the retaining members are flared tab-like member that project outwardly in a linear path from the first height at the base portion to the second height at the end portion.

8. A snap-in roller assembly adapted to be installed in an aperture defined through a wall of a hollow rail of a sliding door, the wall having a pair of opposing surfaces adjacent the aperture, the assembly comprising:
an outer housing having an outer surface;
an inner housing;
at least two roller wheels affixed to the inner housing to maintain the wheels in a fixed position relative to each other;
an adjustment mechanism which adjusts the inner housing to a desired position within the outer housing;
at least one retaining member attached to the outer housing, the retaining member comprising a base portion and an end portion, wherein the base portion is positioned at a first height that is substantially flush with the outer surface of the outer housing and the end portion projects away from the outer surface of the outer housing to a second height that is greater than the first height relative to the outer surface; and
at least one mounting tab affixed to the outer housing and cooperatively positioned with the at least one retaining member so that, when the roller assembly is installed in the aperture, the at least one retaining member and the at least one mounting tab each engage a separate one of the opposing surfaces of the wall to retain the assembly in the lower rail.

9. The assembly of claim 8 wherein the inner housing is a pair of parallel plates each containing a slot therein that accepts a portion of the adjustment mechanism to limit travel of the inner housing to a substantially vertical path with respect to the outer housing.

10. The assembly of claim 8 wherein the outer housing is a pair of substantially parallel plates which overlie the inner housing and limits travel of the inner housing to a vertical path while substantially limiting horizontal movement.

11. The assembly of claim 10 wherein each parallel plate of the outer housing has at least one retaining member.

12. The assembly of claim 10 wherein each parallel plate has two equally spaced substantially collinear retaining members.

13. The assembly of claim 8 wherein the at least one retaining member is a flared tab-like member that project outwardly in a linear path from the first height at the base portion to the second height at the end portion.

14. The assembly of claim 12 wherein the retaining members are flared tab-like member that projects outwardly in a linear path from the first height at the base portion to the second height at the end portion.

15. A method of installing and retaining a roller assembly in sliding patio doors comprising the steps of:
providing a snap-in roller assembly for patio doors, comprising
an outer housing having an outer surface;
an inner housing;
at least two roller wheels affixed to the inner housing to maintain the wheels in a fixed position relative to each other;
an adjustment mechanism which adjusts the inner housing to a desired position within the outer housing;
at least one retaining member comprising a base portion and an end portion, wherein the base portion is positioned at a first height that is substantially flush with the outer surface of the outer housing and the end portion projects away from the outer surface of the outer housing to a second height that is greater than the first height relative to the outer surface; and
at least one mounting tab affixed to the outer housing;
providing a patio door comprising a hollow lower rail with a lower wall having a material wall thickness, wherein a hole is defined in the material wall thickness for receiving the roller assembly and wherein the lower wall has an interior surface and an exterior surface; and
inserting the roller assembly through the hole so that the at least one mounting tab engages the exterior surface of the lower wall of the lower rail and the at least one retaining member engages the interior surface of the lower wall of the lower rail
to retain the assembly in its proper location with respect to the patio door.

16. The method of claim 15 wherein the inner housing is a pair of parallel plates each containing a slot therein that accepts a portion of the adjustment mechanism to limit travel of the inner housing to a substantially vertical path with respect to the outer housing.

17. The method of claim 15 wherein the outer housing is a pair of substantially parallel plates which overlie the inner housing and limits travel of the inner housing to a vertical path while substantially limiting horizontal movement.

18. The method of claim 17 wherein each parallel plate of the outer housing has at least one retaining member.

19. The method of claim 17 wherein each parallel plate has two equally spaced substantially collinear retaining members.

20. The method of claim 15 wherein the at least one retaining member is a flared tab-like member that projects outwardly in a linear path from the first height at the base portion to the second height at the end portion.

21. The method of claim 19 wherein the retaining members are flared tab-like member that project outwardly in a linear path from the first height at the base portion to the second height at the end portion.

22. A sliding door comprising:
a hollow lower rail portion including a bottom wall with an aperture defined therethrough, the bottom wall having an interior surface and an opposing exterior surface adjacent the aperture; and
a roller assembly removably insertable in the aperture of the lower rail portion, the roller assembly comprising:
an elongate outer housing having a pair of opposing sides and a pair of opposing ends, the housing including a pair of mounting tabs and a plurality of selectively deflectable retaining members, each mounting tab projecting outwardly from a separate one of the opposing ends of the housing, the retaining members projecting outwardly from the opposing sides, wherein the pair of mounting tabs confronts the exterior surface of the bottom wall and the retaining members engage the interior surface of the bottom wall adjacent the aperture so as to retain the roller assembly in the lower rail;
an inner housing assembly in the outer housing, the inner housing assembly including a pair of rollers operably coupled with an adjustment mechanism, wherein the rollers are selectively vertically positionable within the inner housing assembly with the adjustment mechanism.
